(19) United States
(12) Patent Application Publication
(10) Pub. No.: US 2020/0018197 A1
(43) Pub. Date: Jan. 16, 2020

(54) CYLINDER RECHARGING STRATEGIES FOR CYLINDER DEACTIVATION

(71) Applicant: EATON INTELLIGENT POWER LIMITED, DUBLIN (IE)

(72) Inventors: JAMES E MCCARTHY, JR., KALAMAZOO, MI (US); Douglas J Nielsen, Marshall, MI (US)

(73) Assignee: EATON INTELLIGENT POWER LIMITED, DUBLIN (IE)

(21) Appl. No.: 16/071,106

(22) PCT Filed: Jan. 19, 2017
(86) PCT No.: PCT/US2017/014184

§ 371 Date: Jul. 19, 2018

Related U.S. Application Data
(60) Provisional application No. 62/280,379, filed on Jan. 19, 2016.

(51) Int. Cl. F01L 13/00; F01L 1/053; F02D 41/00

(52) U.S. Cl. CPC F01L 13/0005; F01L 1/053; F02D 41/0087; F01L 2800/10; F01L 2013/001; F02D 2041/0012; F01L 2820/04; F02D 41/0007

(57) ABSTRACT

A multiple-cylinder diesel engine system comprises an intake valve and an exhaust valve for each of the multiple cylinders. A valve control system is connected to selectively deactivate an intake valve and an exhaust valve for a selected cylinder. A fuel injection control system is connected to selectively deactivate fuel injection to the selected cylinder while increasing fuel to firing cylinders. The multiple cylinder diesel engine enters a cylinder deactivation mode whereby the valve control system deactivates the intake valve and the exhaust valve and the fuel injection control system deactivates the fuel injection to the cylinder while continuing to fire other cylinders of the multiple cylinder diesel engine. The valve control system selectively opens the deactivated intake valve to relieve a negative pressure condition in the deactivated cylinder. Alternatively, the valve control system opens the deactivated exhaust valve to relieve a negative pressure condition in the deactivated cylinder.

### FIELD

This application relates to cylinder deactivation of a multi-cylinder diesel engine and provides methods and systems for managing cylinder pressure and lubrication system.

### BACKGROUND

Cylinder deactivation (CDA) differs from cylinder cut-out. Cylinder cut-out cuts off fuel to a cylinder, but continues to cycle the cylinder valves and piston. Cylinder cut-out is an inefficient energy drain.

Cylinder deactivation stops valve motion and fuel injection for a cylinder. The piston continues to cycle. A quantity of fluid is trapped in the cylinder, but is prone to leaking out. The leaking can cause a negative pressure. The negative pressure can draw excess lubricants into the cylinder and result in contamination.

### SUMMARY

The systems and methods disclosed herein overcome the above disadvantages and improves the art by way of strategies to recharge a cylinder and manage a negative pressure condition developed in a selected cylinder of a multiple-cylinder engine operating in cylinder deactivation (CDA) mode. The strategy comprises of both cylinder pressure management and the lubrication system management.

A method of managing the cylinder pressure of an engine in CDA mode can comprise of intermittently selecting opening of deactivated intake valves or exhaust valves on the selected cylinder and allow fuel from the respective intake or exhaust manifold. The method can further comprise of managing the selective opening to be a low lift late intake valve, or to be on a pre-programmed timing strategy, or be coordinated to follow the respective cycling of a cylinder's piston positions. The method to manage cylinder pressure can also comprise switching between any of 4-stroke mode, 6-strokemode, 8-stroke mode or 2-stroke mode of combustion.

A method of managing an internal lubrication system can comprise of adjusting the metering of oil through a piston ring pack of the selected cylinder to operate in CDA mode. The method can further comprise reducing the lubricating oil pressure to a second ring or the oil ring of the piston pack, addition of a second oil pump and adjusting the pump speeds, adjusting pressure regulators connected to the pistons of the set of reciprocating cylinders, or reducing the amount of lubricating oil sprayed at the selected cylinder.

A method of managing an internal lubrication system to reduce lubricant “leak down” in operating a multiple-cylinder engine in CDA mode can comprise of selectively adjusting pressure of an oil feed entering the deactivated cylinders. This can further comprise of addition of oil pumps, pressure regulators, and bypass systems to selectively adjust the oil feed to the selected deactivated cylinders while maintaining pressure of the oil feed to at least one of the firing cylinders.

A multiple-cylinder diesel engine system comprises a multiple cylinder diesel engine comprising a respective intake valve and a respective exhaust valve for each of the multiple cylinders. A valve control system is connected to selectively deactivate a respective intake valve and a respective exhaust valve for a selected cylinder of the multiple cylinder diesel engine. A fuel injection control system is connected to selectively deactivate fuel injection to the selected cylinder while increasing fuel to firing cylinders. The multiple cylinder diesel engine enters a cylinder deactivation mode whereby the valve control system deactivates the respective intake valve and the respective exhaust valve and the fuel injection control system deactivates the fuel injection to the cylinder while continuing to fire other cylinders of the multiple cylinder diesel engine. The valve control system selectively opens the deactivated intake valve, or the deactivated exhaust valve to relieve a negative pressure condition in the deactivated cylinder.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 shows an explanatory schematic for an engine system.

FIGS. 2A-2C show aspects of cylinder operation.

FIG. 3 shows a computer control system block diagram.

FIG. 4 is an example of a 6-cylinder engine in normal mode.

FIGS. 5A and 5B are examples of the 6-cylinder engine of FIG. 4 in cylinder deactivation mode.

FIGS. 6A-6C are examples of engine lubrication systems.

FIGS. 7A & 7B show parts of an engine piston.

FIG. 8 shows a flow diagram for a method of recharging a selected cylinder in cylinder deactivation mode.

FIG. 9A shows power demand amplitude profiles of an engine in normal mode over time.

FIGS. 9B-9G demonstrate alternative power demand amplitude profiles of an engine in cylinder deactivation mode over time.

FIG. 10A illustrates a camshaft with cam lobes of an engine.

FIG. 10B illustrates a modified cam lobe on a camshaft of an engine.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures. Phrases such as “upstream” and “downstream” are used to assist with directionality of flow from a fluid input point to a fluid output point. Fluids in this disclosure can comprise a variety of compositions, including fresh or ambient air, exhaust gas, other combustion gasses, vaporized fuel, among others. Lubrication fluids, such as oil or synthetic lubricant are combustible, per se, but are to be considered part of a separate fluid circuit from the combustion circuit outside of incidental cross-contamination. This disclosure primarily focusses on diesel engine operation, but tenets of the disclosure can be applied to other fueled engines and engine systems, including those fueled by biofuels and other petroleum products such as gasoline, and including hybrid-electric vehicles. Heavy-duty, light-duty, and medium-duty vehicles can benefit from the techniques disclosed herein. Hybrid vehicles and vehicles such as buses that have start/stop/load duty cycles can also benefit from the disclosure.

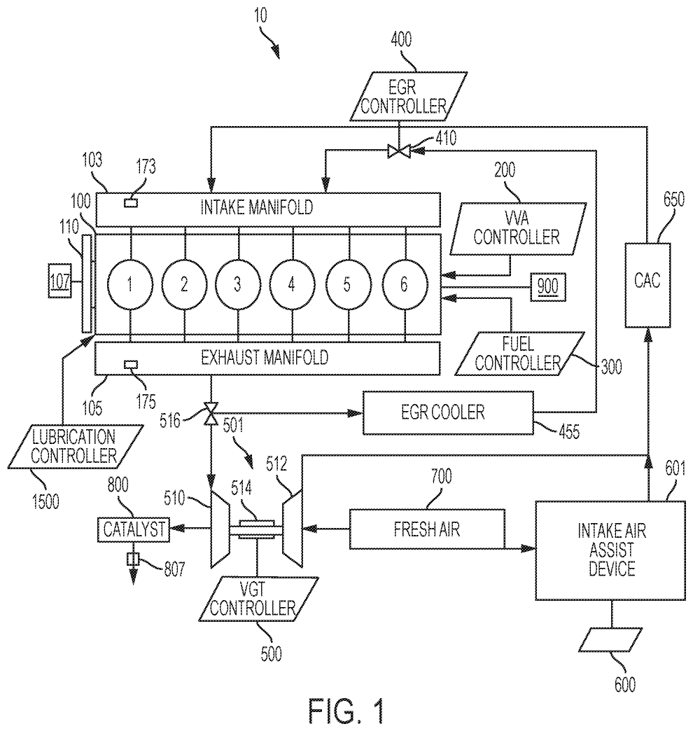

Turning to FIG. 1, a schematic for an engine system 10 is shown. An engine 100 comprises 6 cylinders 1-6. Other numbers of cylinders can be used, but for discussion, 6 cylinders are illustrated. The cylinders 1-6 receive intake fluid, which is combustion gas, such as air, or air mixed with exhaust (exhaust gas recirculation “EGR”), from the intake manifold 103. An intake manifold sensor 173 can monitor the pressure, flow rate, oxygen content, exhaust content or other qualities of the intake fluid. The intake manifold 103 connects to intake ports 133 in the engine block to provide intake fluid to the cylinders 1-6. In a diesel engine, the intake manifold has a vacuum except when the intake manifold is boosted. Cylinder deactivation (“CDA”) is beneficial, because the cylinder can be closed. Fuel efficiency is gained by not drawing the piston down against the manifold vacuum. When the cylinder is deactivated, the crankshaft 101 has less resistance from the piston, and the crankshaft can output more torque from the firing cylinders.

Fuel is injected to individual cylinders via a fuel injection controller 300. The fuel injection controller 300 can adjust the amount and timing of fuel injected in to each cylinder and can shut off and resume fuel injection to each cylinder. The fuel injection for each cylinder 1-6 can be the same or unique for each cylinder 106, such that one cylinder can have more fuel than another, and one cylinder can have no fuel injection, while others have fuel.

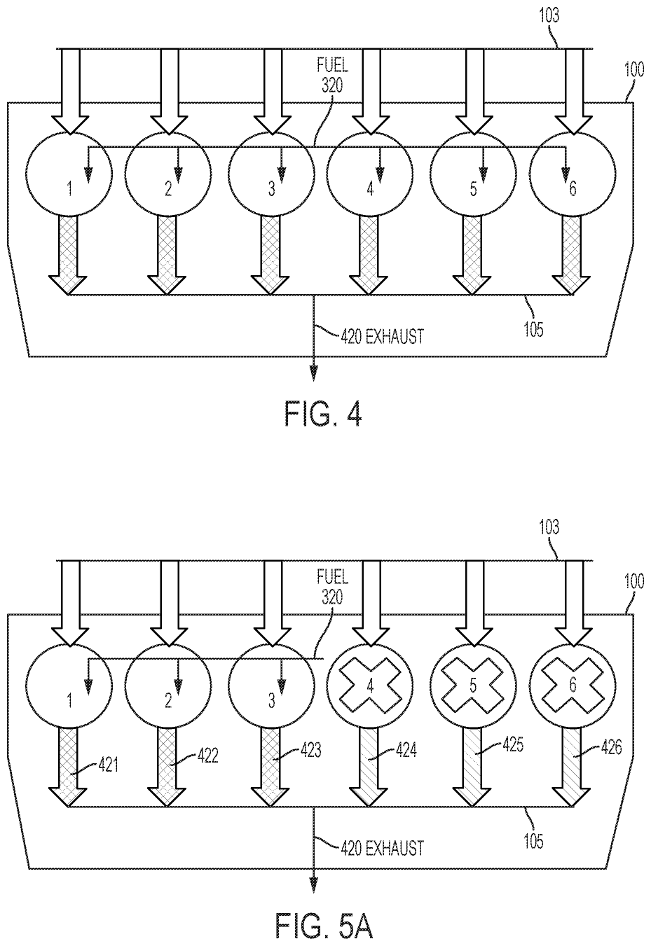

FIG. 4 shows a normal operation mode for an engine system 10 or like engine system. Intake fluid from manifold 103 is provided to each cylinder 1-6. Each cylinder receives fuel 320 and conducts a combustion cycle. Exhaust 420 exits each cylinder 1-6. A normal mode can be used herein during certain load and speed conditions of the engine, such as when full torque output is desired, or when the engine is operating near its optimized set point. Or, for example, when a cruising mode provides a better temperature or NOx output for the engine system than CDA mode.

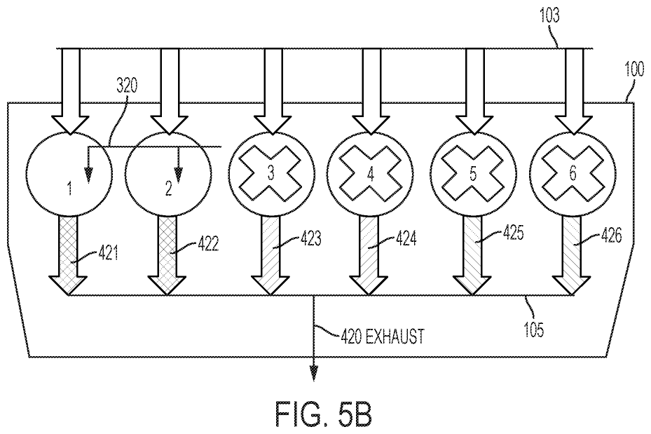

FIG. 5A is an example of a diesel engine operation in cylinder deactivation mode (CDA). Here, half of the cylinders are deactivated. Cylinders 1-3 receive fuel commensurate with the torque output requirement. When the engine is required to maintain a certain torque level, and CDA mode is implemented, it is possible to deactivate cylinders 4-6 while increasing fuel to cylinders 1-3. Because of fuel economy benefits that inure from decreased friction on the totality of cylinders, it is possible to provide less than double the fuel to the firing cylinders 1-3 to obtain the same torque level as firing all six cylinders in normal mode. For example, when shutting off half of the cylinders, the firing cylinders could receive, for example, 1.95 times more fuel to maintain steady torque output during deactivation. So, CDA mode yields a fuel economy benefit by decreasing fuel use for a desired torque output. Here, intake and exhaust valves 130, 150 move as controlled by VVA controller 200 for firing cylinders 1-3. However, intake and exhaust valves 130, 150 are not actuated for cylinders 4-6.

A user input sensor 900 can be linked to the engine system 10 to sense user inputs such as braking, acceleration, start-up mode selection, shut-down mode selection, auxiliary device activation, among others. The user selections can impact the load requirements for the engine system 10, and the power settings for the cylinders 1-6 can be adjusted in response to the user selections. The valve control by VVA controller 200 and fuel injection from fuel injection controller 300 can be tailored based on the user selections sensed by user input sensor 900.

A variable valve actuator (VVA) controller 200 couples to the cylinders 1-6 to actuate intake valves 130 and exhaust valves 150. The VVA controller 200 can change the actuation of the intake valves 130 and exhaust valves 150 so as to open or close the valves normally, early, or late, or combinations thereof, or cease operation of the valves. Early Intake Valve Opening (EIVO), Early Intake Valve Closing (EIVC), Late Intake Valve Opening (LIVO), Late Intake Valve Closing (LIVC), Early Exhaust Valve Opening (EEVO), Early Exhaust Valve Closing (EEVC), Late Exhaust Valve Opening (LEVO), Late Exhaust Valve Closing (LEVC), a combination of EEVC and LIVO or Negative Valve Overlap (NVO) can be implemented by the VVA controller 200. Compression release breaking (CRB) can also be implemented by VVA controller 200. VVA controller 200 can cooperate with valve actuators 185, such as one or more of a hydraulic system, electric latch system, or electric solenoid system to control the intake and exhaust valves 130, 150.

The valve actuators 185 for each cylinder 1-6 can be the same for all cylinders 106, thus enabling each valve of each cylinder to switch between, for example, combustion mode, deactivated mode, or compression release braking (CRB) mode. Or, the valve actuators 185 can differ between the intake valves 130 and the exhaust valves 150, so that certain functionality is only enabled on one or the other of those valves, such as LIVO on intake valves and CRB on exhaust valves. Or, commensurate with below discussions, the functionality can be distributed so that some valves can switch between combustion mode and deactivated mode, while others can switch between, for example combustion mode and CRB mode. And, when more than one intake valve or more than one exhaust valve are used per cylinder 106, the valve actuators 185 can be the same or different for each of those valves.

For example, as shown in FIG. 4, intake fluid is supplied via intake manifold 103 to each cylinder 1-6. Fuel 320 is injected by fuel injector 310 to each of the cylinders 1-6. Exhaust 420 leaves exhaust manifold 105. This all-cylinder operation mode can be enabled by a variety of valve actuators 185. In FIG. 5A, half of the engine 100 does not receive fuel 320. When a start-up mode initiates the sensing of a low temperature condition of the exhaust, deactivating fuel injection to a first cylinder of the engine can comprise inhibiting fuel injection to some cylinders at start-up, or the affirmative deactivation of fuel injection. However, each exhaust stream 421, 422, 423 can differ from having different quantities of fuel 320 injected, or as by having different periods for combustion enabled via valve actuators 185. For example, cylinder 1 could have late intake valve closing (LIVC) enabled to impact the air fuel ratio of that cylinder. The other cylinders could have increased fueling, but normal valve actuation. The resulting exhaust stream 421 differs from exhaust streams 422, 423. Cylinders 4-6 could be compression release braked, and the exhaust streams 424-426 therefore differ from exhaust streams 421-423. In FIG. 5B, combustion exhaust streams 421, 422 differ from cylinder deactivation exhaust streams 423, 423, which differ from CRB exhaust streams 425, 426. Only cylinders 1 & 2 of FIG. 5B receive fuel 320, while the others generate heat via compression, and release the heat per the desired mode.

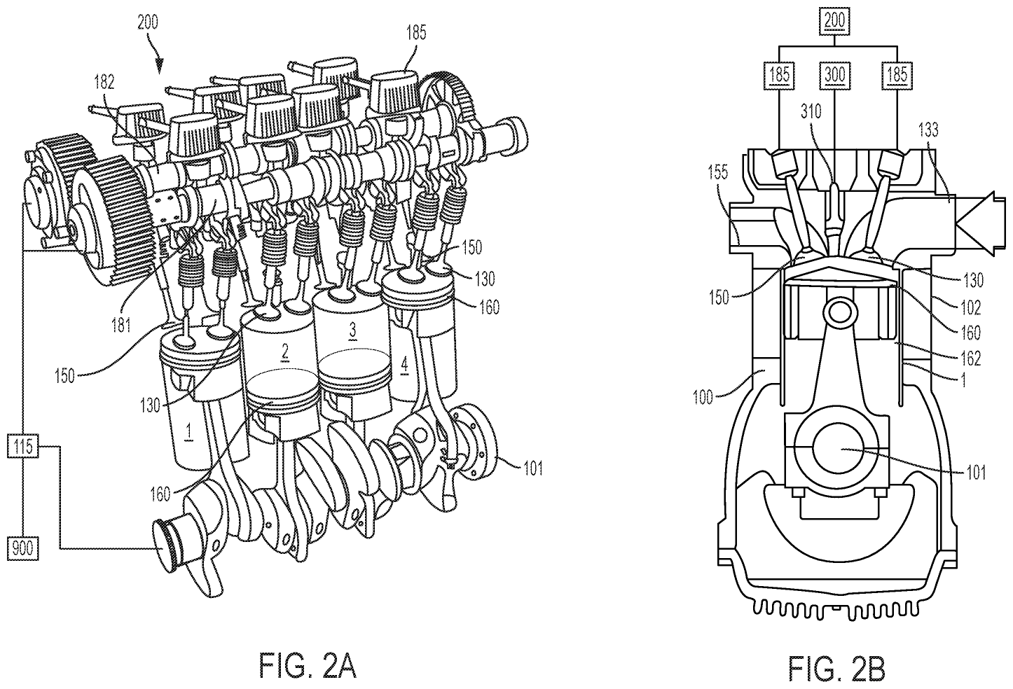

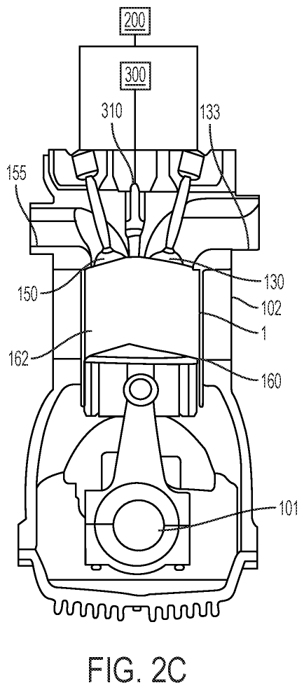

In order for a diesel engine to operate, all of its components must perform their functions at very precise intervals in relation to the motion of the piston. To accomplish this, the engine 100 can be cam or camless, or a hybrid “cam-camless VVA.” So, the intake and exhaust valves 130, 150 can either couple to a cam system for actuation, as the camshafts 181, 182 example of FIG. 2A, a hydraulic rail, a latched rocker arm, other rocker arm, an electro hydraulic actuator, etc. For example, OEMs want engine braking while they want hydraulic lash adjustment (HLA). Few concepts can do both. It is possible to use a rocker arm lost motion capsule with reset to modularly perform HLA and braking. Other designs can include HLA and engine brake in a cam or camless engine.

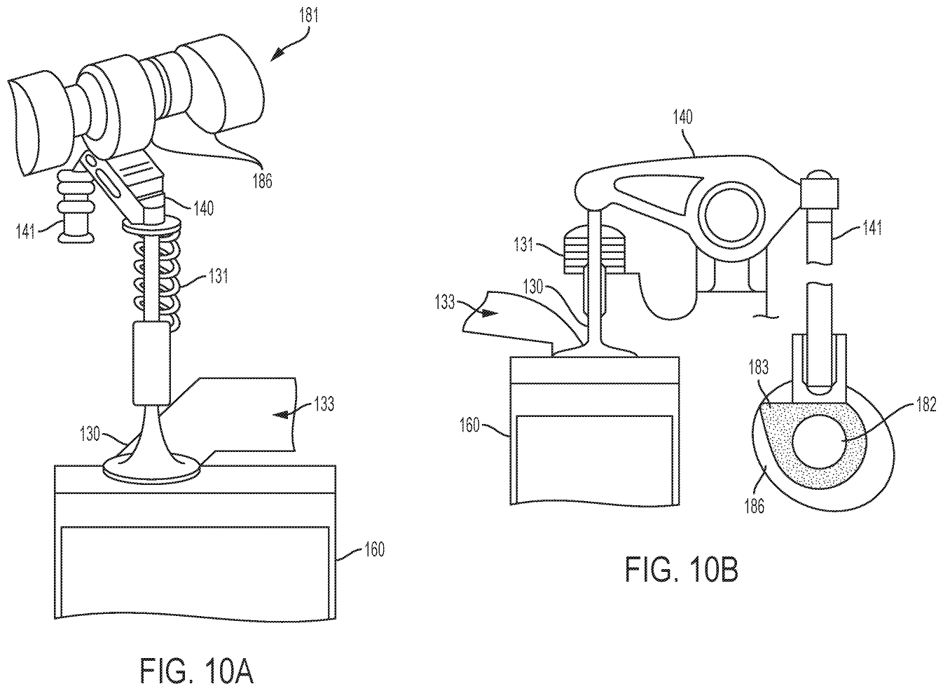

Turning to FIG. 10A, camshaft 181 is a long bar and can have egg-shaped eccentric cam lobes 186 for valve actuators 185. There can be at least one lobe for each valve, at times, two or three lobes per each valve. Each cylinder, and sometimes each valve, can also be assigned a fuel injector 310 (shown in FIGS. 2B & 2C). Each lobe has a follower, such as rocker arm 140. As the camshaft 181 is rotated, the follower 140 is forced up and down as it follows the profile of the cam lobe 186. The followers are connected to the engine's intake valves 130 and fuel injectors 310 through various types of linkages including, for example pushrods 143 and rocker arms 140 (in FIG. 10B). The pushrods and rocker arms transfer the reciprocating motion generated by the camshaft lobes of valve actuators 185 to the valves, opening and closing them as needed. The fuel injectors can connect to the linkages to be run in synchrony with the valves via one or both of mechanical or computer control. The valves can be maintained closed by springs 131. As the valve is opened by the camshaft 181, it compresses the valve spring. The energy stored in the valve spring is then used to close the valve as the camshaft lobe rotates against the following rocker arm 140. Because an engine experiences changes in temperatures, its components must be designed to allow for thermal expansion. Therefore, the valves, valve pushrods, and rocker arms have some method of allowing for thermal expansion which is accomplished by a valve lash. Valve lash is a term given to the “slop” or “give” in the valve train before the cam can start to open the valve. The valves can comprise manual or hydraulically adjustable lash adjusters 141 to account for the valve lash.

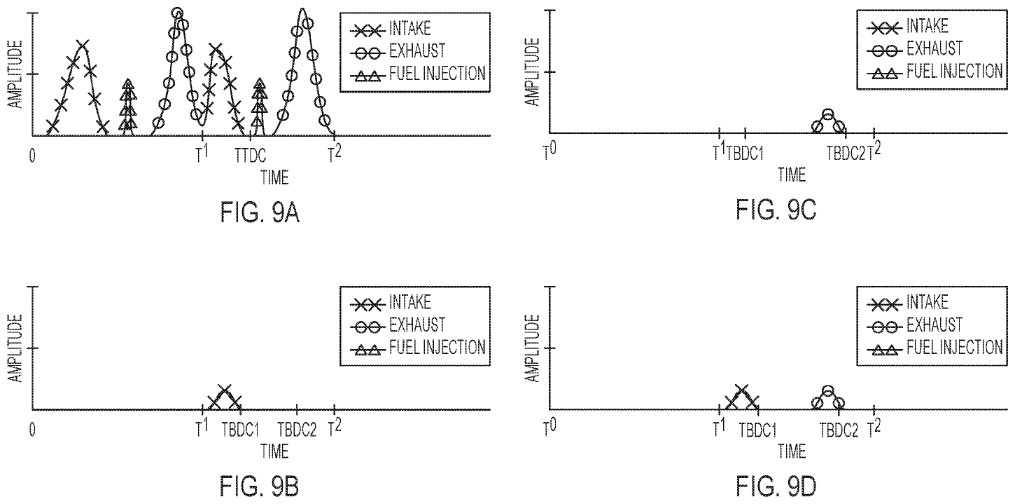

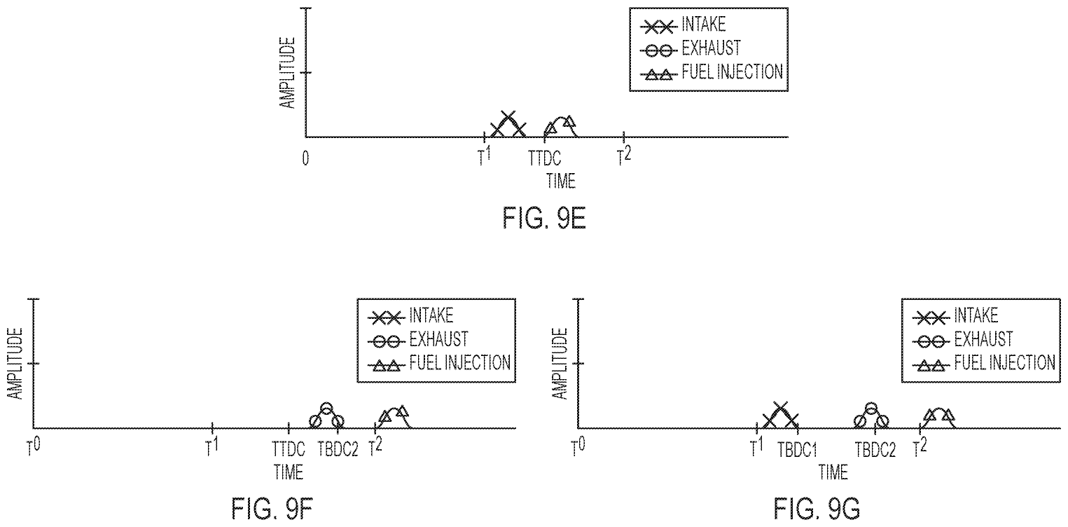

In FIG. 10A, the cam lobe 186 used for valve actuator 185 has an eccentric outer profile, and an inner arm of the rocker arm 140 is movable to select how far the valve travels when the cam lobe 186 presses against the rocker arm 140. By latching and unlatching an internal mechanism, the valve lift profile can go between those drawn in FIG. 9A and those drawn in FIGS. 9B-9D.

Other mechanisms can achieve the valve lift profiles drawn in FIGS. 9A-9D. For example, electrically actuated valves, hydraulically actuated valves, camless direct acting mechanisms, and hybrid cam/camless valve trains can be used to open and close the intake valves 130 and exhaust valves 150 as necessary.

Camshafts 181, 182 can be coupled to be driven by the engine's crankshaft 101 and transfer energy between the two via a torque transfer mechanism 115, which can comprise series of gear sets, belts, or other transfer mechanisms (FIG. 2A). Gears such as idler gears and timing gears allow the rotation of the camshaft to correspond or be in time with, the rotation of the crankshaft 101 and thereby allows the valve opening, valve closing, and injection of fuel to be timed to occur at precise intervals in the piston's travel. To increase the flexibility in timing the valve opening, valve closing, and injection of fuel, and to increase power or to reduce cost, an engine may have one or more camshafts 181, 182, etc. In the larger engines, the intake valves 130, exhaust valves 150, and fuel injectors 310 may share a common camshaft or have independent camshafts.

While FIGS. 2B and 2C show one intake valve 130 and one exhaust valve 150, it is possible to have two intake valves 130 and two exhaust valves 150 per each cylinder, as in FIG. 2A. The engine block 102 is removed for the example of FIG. 2A for clarity, and the cylinders are shown in broken lines.

A diesel engine works by compressing intake fluid in a cylinder 1-6 using a piston 160. Fuel is injected via fuel injector 310. The high heat and compression ignites the fuel, and combustion forces the piston from top dead center (TDC) shown in FIG. 2B to bottom dead center (BDC) shown in FIG. 2C and torque is thereby directed to the crankshaft 101. Diesel operation can be referred to as “4 stroke,” though other operation modes such as 2-stroke, 6-stroke, and 8-stroke are possible and known in the art.

In 4-stroke combustion mode, the piston 160 moves from TDC to BDC to fill the cylinder with intake fluid (stroke 1). The start of the cycle is shown in FIG. 2B, and FIG. 2C shows the end of stroke 1, when the cylinder is full of intake fluid. The piston rises back to TDC (stroke 2). Fuel is injected and ignites to push the piston 160 to BDC (stroke 3). The piston rises again to TDC to expel the exhaust out the exhaust valve (stroke 4). The intake valve 130 is open during stroke 1 and closed during strokes 2-4, though the VVA controller 200 can adjust the timing of opening and closing. The exhaust valve 150 is open during stroke 4 and closed during strokes 2-4, though the VVA controller 200 can adjust the timing of opening and closing. Compression occurs on the second stroke, and combustion occurs on the third stroke. The application will discuss 4-stroke combustion techniques in detail, but where compatible, the 4-stroke combustion techniques can be applied to augment art-recognized 6-stroke or 8-stroke combustion techniques. 2-stroke engine-braking techniques can be used with 2-, 4-, 6- or 8-stroke combustion techniques.

Turning to FIG. 9A, an amplitude of the power demand for a typical engine is illustrated for a 4-stroke combustion cycle over time showing the energy it takes to open the valves, inject fuel, and open the exhaust valve, whether electric or torque or both. The amplitude on the y-axis is the power required for actuating an intake valve, fuel injection, and an exhaust valve for one of the cylinders 1-6. A respective piston 160 reciprocates within a respective cylinder 1-6 from TDC to BDC. FIG. 9A simplifies the issue of whether variable valve actuation is used, and repeats the same valve lift and fuel injection patterns for each cylinder cycle. Overlaps between valve openings and closings are not drawn, though in practice, the intake valve can begin opening while the exhaust valve is still closing. Variations to contrast techniques such as timing the valves for scavenging, “swirl,” “cylinder wetting,” “churn” etc. are not shown. From time zero T0 to time T1, the cylinder completes a 4-stroke cycle. The timeline starts with the piston for this cylinder near TDC after an exhaust stroke. Stroke 1 moves the piston 160 from TDC to BDC while the intake valve 130 opens to induct intake gases. In some cases, the piston can begin travelling back to TDC before the intake valve has closed all the way, but stroke 2 is a compression stroke, as the piston pushes up against closed intake valve 130 and closed exhaust valve 150. Fuel injection occurs at or near TDC. When the fuel is diesel, the thermodynamics of the compression ignites the fuel and the piston moves from TDC to BDC on stroke 3, also called a power stroke. The exhaust valve can begin to open at or near BDC of stroke 3, and as the piston returns to TDC, the cylinder contents exit past the exhaust valve 150.

Exhaust gases leave cylinders through exhaust ports 155 in engine block 102. Exhaust ports 155 communicate with an exhaust manifold 105. An exhaust manifold sensor 175 can monitor the pressure, flow rate, oxygen content, nitrous or nitric oxide (NOx) content, sulphur content, other pollution content or other qualities of the exhaust gas.

A controllable valve 516 can be included to direct timing and quantity of fluid to the turbine 510 and catalyst 800 or to an optional EGR cooler 455 and EGR circuit that returns exhaust gases to the intake manifold 103 for exhaust gas recirculation (EGR).

Exhaust gas is filtered in an aftertreatment system comprising catalyst 800. At least one exhaust sensor 807 is placed in the aftertreatment system to measure exhaust conditions such as tailpipe emissions, NOx content, exhaust temperature, flow rate, etc. The exhaust sensor 807 can comprise more than one type of sensor, such as chemical, thermal, optical, resistive, velocity, pressure, etc. A sensor linked with the turbocharger 501 can also be included to detect turbine and compressor activity.

Exhaust can exit the system after being filtered by the at least one catalyst 800. Or, exhaust can be redirected to the intake manifold 103. An optional EGR cooler 455 is included. An EGR controller 400 actuates an EGR valve 410 to selectively control the amount of EGR supplied to the intake manifold 103. The exhaust recirculated to the intake manifold 103 impacts the air fuel ration (AFR) in the cylinder. Exhaust dilutes the oxygen content in the intake manifold 103. Unburned fuel from an aftertreatment fuel doser, or unburned fuel remaining after combustion increases the fuel amount in the AFR. Soot and other particulates and pollution gases also reduce the air portion of the air fuel ratio. While fresh air brought in through the intake system 700 can raise the AFR, EGR can lower AFR, and fuel injection to the cylinders can lower the AFR further. Thus, the EGR controller 400, fuel injection controller 300 and intake assist controller 600 can tailor the air fuel ratio to the engine operating conditions by respectively operating EGR valve 410, fuel injector 310, and intake assist device 610. So, adjusting the air fuel ratio to a firing cylinder can comprise one of boosting fresh air from intake system 700 to the at least one firing cylinder by controlling an intake air assist device 601, such as a supercharger, or decreasing air fuel ratio to a firing cylinder by boosting with exhaust gas recirculation to the firing cylinder. A charge air cooler 650 can also optionally be included to regulate intake flow temperature.

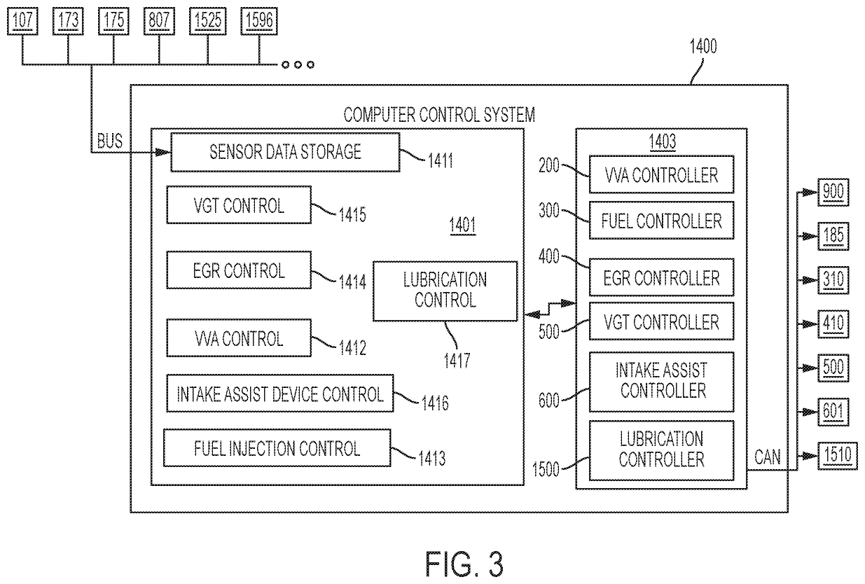

An engine, as discussed in FIG. 1, can have a plurality of support systems comprising of engine cooling, engine lubrication, fuel system, air intake systems, and exhaust system. Each system can operate together under an engine's desired performance by being able to adjust respective activities through a computer-controlled system as indicated in FIG. 3. For example, the pistons 160 reciprocate from TDC to BDC as explained above, while fuel injection controller 300 modulates timing and amounts of fuel and while VVA controller 200 modulates valve opening and closing. Fuel injection controller 300 is part of a computer-controllable fuel injection system configured to inject fuel in to the multiple cylinders 1-4 or 1-6. VVA controller 200 is part of a system for respective computer-controllable intake valves 130 and exhaust valves 150.

A computer control network is outlined in FIG. 3, and is connected to fuel injector 310 of fuel injection system and valve actuators 185 for respective intake valves and respective exhaust valves. When included, the computer control system is connected to optional EGR valve 410, variable geometry turbine 510, and intake air assist device 601. The network can comprise a BUS for collecting data from various sensors, such as output/input (crankshaft) sensor 107, intake manifold sensor 173, exhaust manifold sensor 175, exhaust sensor 807, catalyst sensor 809, user input sensor 900, etc. The sensors can be used for making real-time adjustments to the fuel injection and valve opening and closing timing. Additional functionality can be pre-programmed and stored on the memory device 1401. The additional functionality can comprise pre-programmed thresholds, tables, and other comparison and calculation structures for determining power settings for the cylinders, durations for the power settings and number and distribution cylinders at given power settings. For example, a sensed vehicle start up selection, accessory selection, gear selection, load selection or other sensor feedback can indicate that an exhaust temperature is or will be too low. In addition to temperature thresholds for entering and exiting thermal management strategies, it is possible to apply load thresholds. Load thresholds are particularly useful for determining the power setting aspects outlined below, though it is possible to provide real-time calculations via the computer control system 1400.

Memory device 1401 is a tangible readable memory structure, such as RAM, EPROM, mass storage device, removable media drive, DRAM, hard disk drive, etc. Signals per se are excluded. The algorithms necessary for carrying out the methods disclosed herein are stored in the memory device 1401 for execution by the processor 1403. When variable valve control is implemented, the VVA control 1412 is transferred from the memory device 1401 to the processor for execution, and the computer control system functions as a VVA controller. Likewise, the computer control system 1400 implements stored algorithms for EGR control 1414 to implement an EGR controller 400; implements stored algorithms for intake assist device control 1416 to implement intake assist controller 600; and implements stored algorithms for fuel injection control 1413 to implement fuel injection controller 300. When implementing stored algorithms for VVA control 1412, various intake valve controller and exhaust valve controller strategies are possible relating to valve timing and valve lift strategies, as detailed elsewhere in this application, and these strategies can be implemented by VVA controller 200. The processor can combine outputs from the various controllers, for example, the processor can comprise additional functionality to process outputs from VGT controller 500 and intake assist controller 600 to determine a command for valve 516. A controller area network (CAN) can be connected to appropriate actuation mechanisms to implement the commands of the processor 1403 and various controllers.

While the computer control system 1400 is illustrated as a centralized component with a single processor, the computer control system 1400 can be distributed to have multiple processors, or allocation programming to compartmentalize the processor 1403. Or, a distributed computer network can place a computer structure near one or more of the controlled structures. The distributed computer network can communicate with a centralized computer control system or can network between distributed computer structures. For example, a computer structure can be near the EGR valve 410 for EGR controller 400, another computer structure can be near the intake and exhaust valves for variable valve actuator 200, yet another computer controller can be placed for fuel injection controller 300, and yet another computer controller can be implemented for intake assist controller 600. Subroutines can be stored at the distributed computer structures, with centralized or core processing conducted at computer control system 1400.

It is possible for the stored processor-executable control algorithms to be called up from the memory device 1401 in to the processor 1403 for execution when, for example, a start-up or shut-down operation mode is selected, as by a user pressing a button, turning a key, engaging a manual brake, etc. Or, user input calls up an acceleration algorithm or a deceleration algorithm from the memory device 1401 for execution by the processor 1403 by increasing or decreasing pressure on an accelerator pedal or a brake pedal. User input can be used alone or in combination with sensed operating conditions to implement the strategies outlined herein.

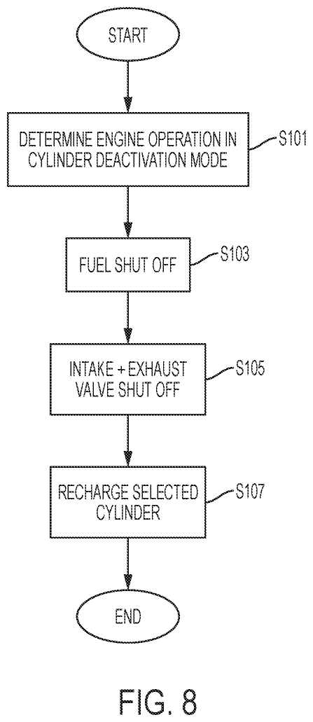

FIG. 8 shows a simplified method to recharge a cylinder in cylinder deactivation mode. In step S101, the control algorithm determines that the engine has at least one cylinder selected for cylinder deactivation mode. Being at a particular load, pollution control step, vibration control step, or other engine status can indicate start of the CDA mode. Pre-programming algorithms, real-time calculations, and combinations of the two can be used to determine initiation of the CDA mode. Once the CDA mode is determined, the fuel injector, intake valve and exhaust valve for the selected cylinder are deactivated in steps 103 and 105 respectively. This terminates fluid intake, fuel injection, and fluid exhaust to and from the selected cylinder. Over time, as the reciprocating piston 160 in the selected cylinder is still active, the fluids inside the cylinder leak causing negative pressure (or vacuum) conditions inside the cylinder. The resulting vacuum pulls oil from the engine's lubrication system causing engine contamination. To prevent such oil contamination and vacuum condition, in Step 107, cylinder recharging strategies can be implemented comprising cylinder pressure management, lubricating system oil flow reduction, and piston ring modification. Other benefits inure, such as airflow control and temperature control.

### Pressure Management Strategies During Cylinder Deactivation Mode:

For a multiple-cylinder engine in a cylinder deactivation (CDA) mode, the selected cylinders have both intake valves 130 and exhaust valves 150 closed, but the piston 160 reaches top dead center and bottom dead center as usual, because the piston is not deactivated from the crankshaft 101. The piston recuperates most of the energy spent rising to top dead center (compressing the fluid in the closed cylinder) when that fluid expands and the piston cycles to bottom dead center. However, fluid losses occur, and eventually a negative pressure (or vacuum) develops in the cylinder. As the piston continues to cycle, the deactivated cylinder develops such vacuum, which then can contaminate the engine by drawing oil from the internal engine lubrication system into the cylinder. This loss of oil into the cylinder disrupts the engine's lubrication system as well as creates engine pollution. Therefore, cylinder pressure management strategies to recharge deactivated cylinders are needed to bias the oil back to the oil pan and prevent engine contamination.

A method and pressure management strategy for a deactivated cylinder can comprise of recharging the deactivated cylinder with fluid from either the intake manifold 103, exhaust manifold 105, or fuel injectors 310. For this, the variable valve actuator (VVA) controller 200 can couple to the respective deactivated cylinders to intermittently actuate the intake valves 130 to open and then close. Depending on the engine operation, pressure in the intake and exhaust manifolds 103, 105, vibration, and exhaust temperature of the engine, the VVA controller 200 can couple instead to exhaust valves 150 to open and then close. It is also possible to intermittently selectively open both the intake valves 130 and exhaust valves 150.

In another aspect of recharging a deactivated cylinder, in addition to selectively opening the deactivated intake or exhaust valves, a selected volume of fuel can be added by actuating the deactivated fuel injector 310. The additional fluid can compensate for the loss of fluid and leading to the negative pressure condition in a deactivated cylinder.

In another aspect of recharging a cylinder to combat a negative pressure condition in a selected cylinder, the 4-stroke operation technique can be switched between a 4-stroke combustion technique to art-recognized 6-stroke or a 8-stroke combustion techniques which include additional aspects of compression and injection after the intake valve has closed and prior to the exhaust valve opening. Furthermore, the typical 4-stroke engine can be also switched to art-recognized 2-stroke operation.

In one aspect of the pressure management strategy, either intake valves 130 or exhaust valves 150 can be pulsed periodically to open, such as every piston cycle (T0 to T1 in the case of a 4-stroke example), to allow higher pressure fluid to enter the cylinder from respective intake manifold or exhaust manifold 103, 105. The valve opening can be timed to take advantage of a boosting of the pressure in the intake manifold 103 or a back-pressure in the exhaust manifold 105. So, the valve opening strategy can be linked to the operation of valves 410 or 516, or action by compressor 512 or intake air assist device 601, or inaction of turbine 510. Or, the intermittent period could be a pre-determined timing strategy. Selection of a timing set point can be part of the engine computer system, for example, valve opening could be done at 20 to 30 second intervals, or after a predetermined number of piston reciprocations. Other ranges of time for selecting a timing set point can be a time around 5 minutes of deactivation or around 20 minutes of deactivation. The timing set point depends in large part on the rate at which oil builds up in the cylinder to an unacceptable contamination level. Reducing oil pressure to the oil feed can extend the timing set point, because there is less oil pressure and less sprayed oil to bias back towards the oil pan.

Comparison of FIG. 9A and FIG. 9B illustrates the power demand profiles to open valves, inject fuel, and open exhaust valves, between a normal mode versus a cylinder deactivation mode for a 4-stroke combustion cycle. In FIG. 9A, during a normal mode, from time zero to time T1, a firing cylinder opens the intake valve, has fuel injection, then opens the exhaust valve. From time T1 to time T2, this happens again. On the cylinder deactivation mode cylinder, as illustrated in FIG. 9B, all three valves, intake, exhaust, and fuel, are deactivated. However, to relieve vacuum built up in the deactivated cylinder, the cam or electronic control is modified to open the intake valve slightly, resulting in a minor blip for the intake valve profile. Other variations are possible, up to full intake valve opening. FIG. 9C shows a minor exhaust valve opening, which can also vary up to full exhaust valve opening. FIG. 9D shows an alternative where both an intake valve and an exhaust valve comprise a minor recharge mode valve opening profile. The number of cycles preceding the recharge mode valve opening can be varied based on a number of factors and timing strategies, from temperature, vacuum condition, timing, etc.

In one aspect of the pressure management strategy, the VVA controller 200 actuator can couple with the intake valves 130 to open valves in a low-lift, late intake (LIVO) modified mode. Similarly, the VVA controller 200 actuator can couple with the exhaust valves 150 to open exhaust valves in LEVO mode.

Or, if the engine is a cam system, the cam can be modified to include a minor blip in the design. Then the intake valve can couple to this cam system for actuation of the intake valve such that the valve is opened slightly. FIG. 10B shows an example of how the cam can be modified to comprise a curve or bump 183 in its outer surface to cause the lift profile to comprise a minor blip to create a low lift valve opening scenario to recharge the deactivated cylinders. A latch can be included in the rocker arm 140 to control whether the bump 183 on the cam lobe 186 is transferred to the valve, drawn as intake valve 130.

Another method of pressure management in the deactivated cylinder can comprise of opening the intake valve as a piston of the set of reciprocating pistons approaches or reaches the bottom dead center of the cylinder. At this point, the cylinder is fully expanded and beneficial to maintain the cylinder pressure. This action can keep the pressure in the cylinder at or above the crank-case pressure. This can be seen in FIGS. 9C & 9D, where times TBDC1 & TBDC2 indicate when the piston has travelled to bottom dead center. The piston is at top dead center at times T0, T1, TTDC, & T2. The recharge mode valve openings can begin just as the piston reaches BDC, or slightly before the piston reaches BDC. The recharge mode valve opening profile can be centered about time TBDC1 or TBDC2, or offset to begin before or after those times.

Turning to FIGS. 9E-9G, fuel injection can be used to cause a hot recharge event. After one or both of the intake valve 130 or exhaust valve 150 being opened to relieve negative cylinder pressure, or to bring cylinder pressure up for the purpose of biasing lubrication oil to the oil pan, a small fuel injection can be included. The small fuel injection permits a minor combustion event to re-pressurize the cylinder and prevent deleterious contamination of the cylinder, as by too much oil building up in the cylinder or as by acquiring too great of a heat differential between firing mode and deactivated mode cylinders. In FIG. 9E, the fuel injection occurs just after the piston reaches top dead center at time TTDC. Compression ignition can burn the fuel. In FIGS. 9F & 9G, the fuel injection occurs after the exhaust valve opens and closes. This can be at the peak of piston travel just after time T2. The exhaust valve can benefit from an early exhaust valve opening technique to open and close before the piston rises to TDC at time T2.

Another method of pressure management can include a boost device to add pressure to the intake manifold of the diesel engine.

Another method of pressure management in the deactivated cylinder can comprise of the VVA controller 200 valve actuators 185 being coupled with control logic comprising of maintaining a pressure in the cylinder that expels more oil than leaks down, or maintaining a pressure above a certain vacuum point, or maintaining a positive pressure in the cylinder, or biasing the travel of the oil towards the oil pan as discussed elsewhere.

The use of the disclosed strategies can vary based on the power demands of the engine.

### Lubrication Reduction Strategy for Cylinder Deactivated Engine Block

A multiple-cylinder engine entering the CDA mode is beneficial because it prevents fluid-flow through the cylinder, prevents the cylinder from robbing resources allocated to the other active cylinders, and prevents energy drain to activate the valves.

A multiple-cylinder engine can have support systems comprising, engine cooling, engine lubrication, fuel system, air intake systems, exhaust system, etc. The internal engine lubrication system provides a flow of lubricants (or oil) to all metal-to-metal moving parts of an engine and create a thin film between them. Without the oil film, the heat generated due to the friction between the metal-to-metal contacts could melt the engine parts or otherwise destroy the operability of the engine. Once between the moving parts, the oil serves to lubricate the surfaces. When part of a circuit, the oil can cool the surfaces by absorbing the friction-generated heat.

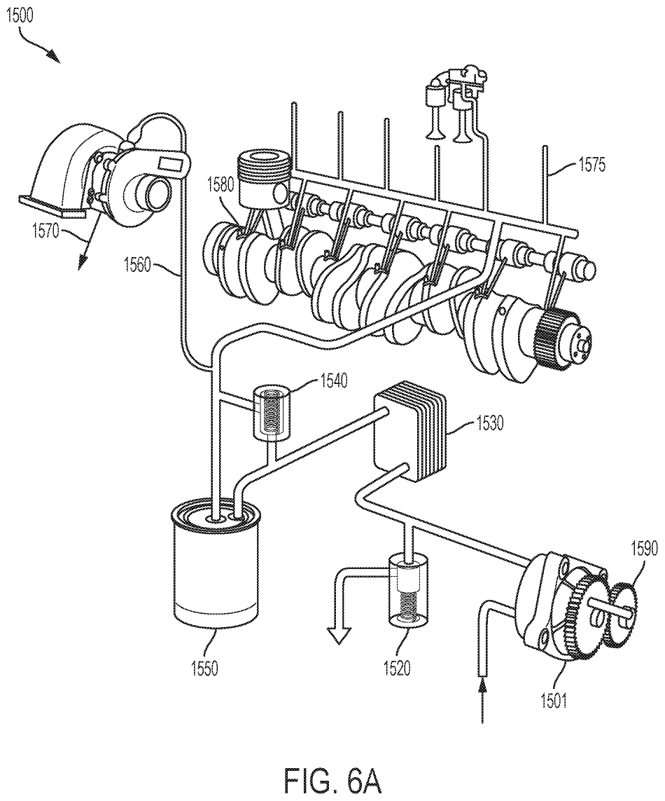

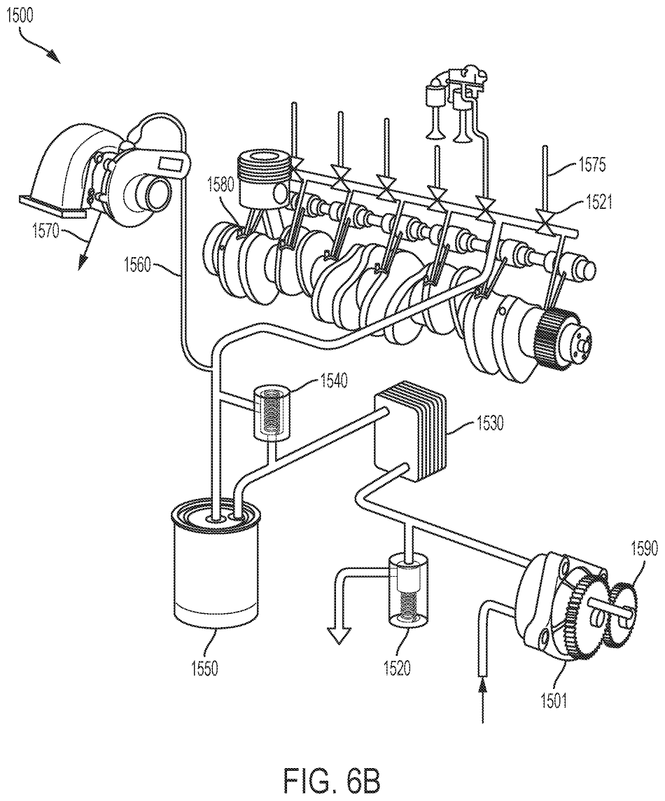

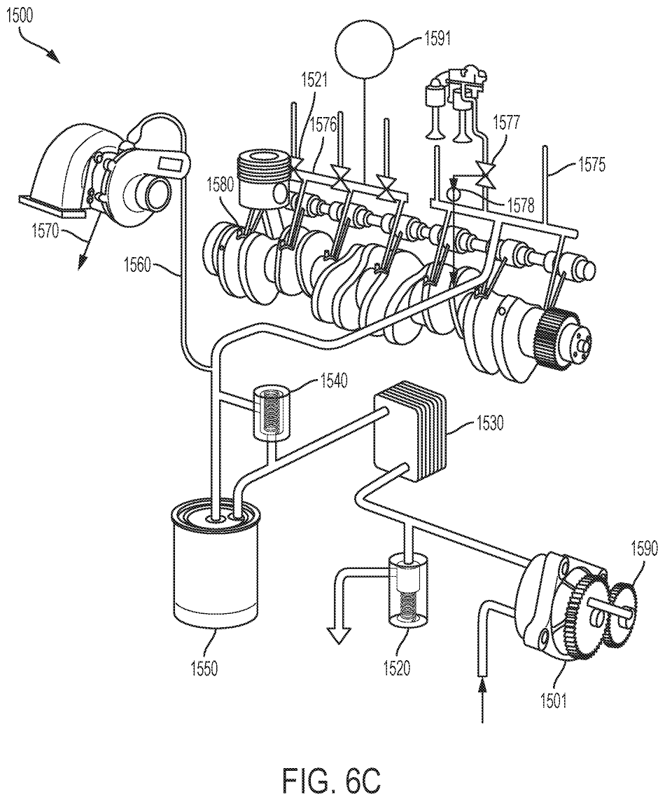

Turning to FIGS. 6A-6C, examples of lubrication systems are shown for a diesel engine. The pistons and valve sets are not replicated to provide clarity for the oil gallery circuits. The lubrication system can comprise a lubricating oil pump 1501, pressure regulator 1520, oil cooler 1530, oil filter 1550, oil galleries 1575, oil pressure sensor 1525, oil level sensor 1596, and oil sump 1595. The lubrication system provides oil into the actuators and valves connected to the engine's cylinder through a plurality of feed lines that make up the oil galleries 1575. The lubrication system can also have its own lubrication control 1417 as part of the engine computer control system 1400. Feedback from the oil pressure sensor can be used to control one or both of the pump speed of the lubricating oil pump 1501 or the pressure setting of the pressure regulator 1520.

A diesel engine operating in the normal mode ordinarily maintains a positive pressure from entering fluid and from the expansion and compression of the fluids. This positive pressure pushes the oil out of the cylinder, keeping the oil in its desired position. However, in the CDA mode, by selectively deactivating the intake and exhaust valves and fuel, the only fluid inside the cylinder is trapped fluid in the deactivated cylinder. Over time, the cycling piston, that is still connected to the moving crankshaft, inside the deactivated cylinder causes the trapped fluid to leak out creating a negative pressure condition. Thus, oil from various valves and lubrication areas around the deactivated cylinder can be vacuumed into the cylinder, or oil on the piston “leaks down” in the cylinder, which robs from the engine lubrication system and ends up causing engine contamination. One of the strategies to reduce the oil entering the deactivated cylinder is to adjust the oil flow of the internal lubrication system into the oil galleries 1575. This can be achieved by reducing the pump speed of the lubricating oil pump 1501 when cylinder deactivation mode is entered. Or, the pressure setting of the pressure regulator 1520 can be adjusted to restrict the oil pressure to the deactivated cylinder. If all cylinders 1-4 or 1-6 are configured to switch between firing mode and deactivation mode, then the oil galleries to these cylinders can be shared, and the pressure settings can be shared as in FIG. 6A. However, more discrete control of the oil galleries can be implemented to permit cylinder-by-cylinder control of oil pressure to the cylinder. For example, each cylinder can have a dedicated computer-controllable pressure regulator 1521 to permit discrete pressure selections for the cylinder oil pressure feed. The pressure regulator 1520 and 1521 can be, for example, a spool valve, a solenoid valve, or other flow regulation mechanism. Additional capsule-level control can be included as part of the valve assembly to restrict oil leak-down from the valves.

A method to reduce oil feed entering the deactivated cylinder can comprise of deactivating the pressure of the oil feed towards a plurality of oil galleries towards the CDA cylinders while maintaining the pressure of the oil feed to the firing cylinders. This can be accomplished by individual control of the pressure regulators 1521 as in FIG. 6B, or it can be accomplished by dividing the engine in to halves, as shown in FIG. 6C. The oil galleries 1575 are divided in to two galleries. Cylinders 1-3 can comprise a dedicated computer controllable lubricating oil pump 1591 on gallery 1576. Further control for each cylinder can be had via pressure regulators 1521. Cylinders 1-3 are configured for selectively converting between cylinder deactivation mode and firing mode. Cylinders 4-6 are configured for firing mode, and possibly another mode, but have a separately controlled lubricating oil pump 1501 on oil gallery 1575. The second oil pump 1591 and pressure regulators 1521 can comprise corresponding control logic under command of lubrication control 1417. The control logic can include algorithms for lubrication system actuators 1510 to adjust the oil flow into the oil galleries 1575. Actuators 1510 can be also coupled with alternate actuators entering the cylinder into CDA mode. When any or all of cylinder 1-3 enter cylinder deactivation mode, the pressure to the oil gallery can be reduced so that not as much oil is distributed in the cylinder. This reduces contamination and reduces waste.

Another method to reduce oil entering the deactivated cylinder can comprise of a lubrication system wherein the oil flow into selected deactivated cylinders is curtailed by opening a series of bypass lines 1577 with one-way valves 1578 back to oil feed lines or the oil galleries 1575, 1576.

Reducing oil in the deactivated cylinders is possible without destroying the engine because CDA changes the need for lubrication. During CDA mode, the engine forces are lower for the deactivated cylinders. There are less friction losses, so there is less need for oil. Repeated compression strokes on the trapped gasses can increase heat, but the heat can be lower than that experienced during combustion. Because of this, it is possible to separate cooling and lubrication circuits and strategies. For example, it is possible to reduce the amount of lubricant sprayed in the cylinder to cool it, and it is possible to deactivate oil to the valve altogether. Using a controllable valve, such as a three way valve, such as a spool valve, for pressure regulator 1521 permits tailoring what portions of the oil supply lubricate the valves and what portions lubricate the cylinder walls, cylinder liner or sleeve 162.

### Piston Modifications for Negative Cylinder Pressure Experienced During Cylinder Deactivation

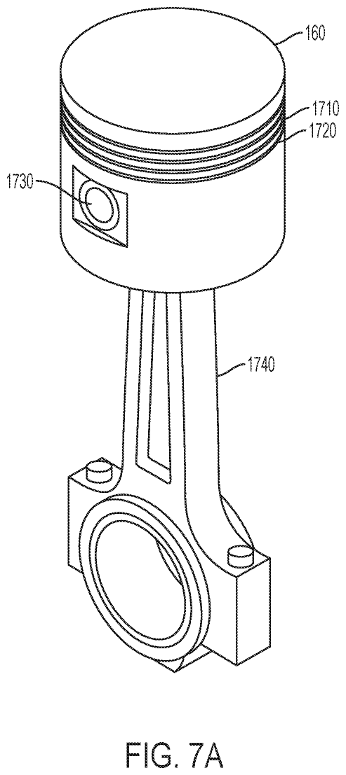

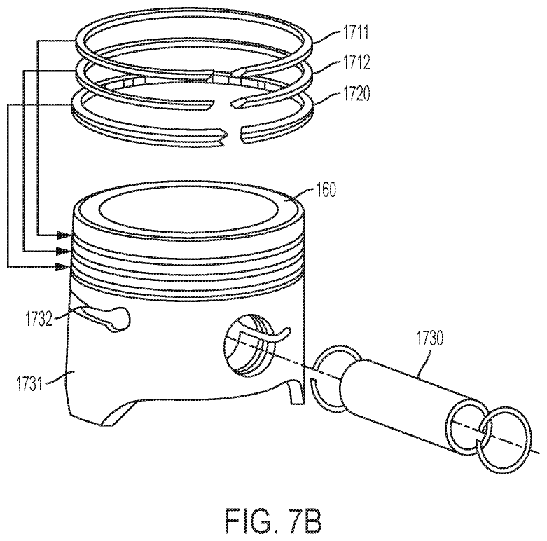

Turning to FIGS. 7A and 7B, a piston 160 is shown with compression rings 1710 and oil rings 1720. A piston of an internal combustion engine transforms the energy of the expanding gasses into mechanical energy. The connecting rod 1740 connects the piston 160 to the crankshaft 101, as shown in FIG. 1. The rods are typically made from drop forged, heat treated steel to provide the required strength. Each end of the rod is bored, with a smaller top bore connecting to the piston pin (wrist pin) 1730 in the piston. The large bore end of the rod is split in half and bolted to allow the rod to be attached to the crankshaft 101. Diesel engine connecting rods can be drilled down the center to allow oil to travel up from the crankshaft and into the piston pin and piston for lubrication. The oil can leak along a groove or along the second ring 1712 via connectivity to the drilled hole. Alternatively, a spray mechanism can be seated under the piston and in the cylinder to spray oil in the cylinder when the piston 160 is at TDC. The sprayer can be connected to the oil gallery 1575, 1576. The piston 160 rides inside the cylinder against a cylinder wall. The cylinder wall can comprise a liner or sleeve 162 (FIGS. 2A and 2B), or the cylinder wall is integrally formed in the engine block.

The piston 160 in FIG. 7B shows piston rings comprising of a top ring 1711 which maintains most of the cylinder pressure, a second ring 1712 which seals against other issues, and an oil ring 1720 which typically controls the oil. The piston rings collectively serve to seal the combustion chamber so that the fluids inside the cylinder are prevented from bypassing the piston and to improve heat transfer from the piston to the cylinder wall. The oil ring 1720 serves to regulate the engine oil consumption by scraping oil from the cylinder walls back to the oil sump 1595. The cylinder wall, liner or sleeve 162 can comprise honing, such as a cross-hatch pattern. When lubrication oil is sprayed in the cylinder from the gallery 1575 or 1576, the oil control ring 1720 spreads the oil across the honing to coat the cylinder with lubrication. Excess oil is scraped and falls back towards the crankshaft and in to the oil pan beneath the crankshaft. Leaked oil can circulate in neck 1732 or from holes in the glands for second ring 1712 or oil ring 1720 and likewise be scraped back to the oil pan.

In CDA mode, as the deactivated cylinder approaches negative pressure conditions, the cylinder can be over-lubricated by the sprayer. This can cool the cylinder too much, waste oil, or contaminate the charge with oil unnecessarily. In addition, the CDA mode can create a vacuum condition that pulls the lubrication oil past the oil control ring 1720. This can unnecessarily coat the top ring 1711 and second ring 1712 and further contaminate the cylinder when the vacuumed oil is pulled in to the cylinder. The vacuum condition can also pull the oil off the valves and into the cylinder causing the oil “leak down” situation. This can result in engine contamination. To reduce such engine contamination, the cylinder can be recharged with positive pressure and effectively push the oil back towards the oil ring 1720. The oil ring can then continue to maintain a thin lubrication film between moving parts while preventing excess oil leakage.

A method to manage over-lubrication of the cylinder can include adjustments of the oil ring. The oil ring can be modified to curtail metering of oil through the piston rings because the building negative pressure in CDA mode. Also, the over-lubrication can be combatted by recharging the cylinder.

A method to adjust metering of oil in a deactivated cylinder is possible by opening either of the intake valve or exhaust valve on the respective cylinder to restore the positive pressure. It is also possible to operate a boost device, such as compressor 512 or intake air assist device 601, to increase positive pressure in the intake manifold 103 and then selectively open an intake valve 130 to allow fluid into the deactivated cylinder. The additional fluid can supply positive pressure in the subsequent compression stroke to bias the oil back into the oil pan instead of into the cylinder and effectively reverse the “leak down” condition. Also, a back pressure in the exhaust manifold 105 can permit the use of exhaust valve 150 opening to recharge the deactivated cylinder.

A method to adjust metering of oil in a deactivated cylinder is also possible by opening one of the intake valve while the respective piston of the set of reciprocating pistons is either near or reaches the bottom dead center of the cylinder in CDA mode.

Other implementations will be apparent to those skilled in the art from consideration of the specification and practice of the examples disclosed herein. It is intended that the specification and examples be considered as exemplary only, with the true scope of the invention being indicated by the following claims.

1. A method for cylinder deactivation in a multiple-cylinder diesel engine, comprising:
selectively deactivating fuel injection to a selected cylinder of the diesel engine;
selectively deactivating an intake valve and an exhaust valve for the selected cylinder in the diesel engine;
firing at least one of the remaining cylinders of the diesel engine while the selected cylinder is deactivated;
cycling a set of reciprocating pistons in both the selected cylinder and the firing cylinders; and
intermittently selectively opening one or both of the intake valve and the exhaust valve for the selected cylinder to relieve a negative pressure condition in the selected cylinder.

2. The method of claim 1, wherein the selective opening is a low-lift, late intake valve opening event (LIVO).

3. The method of claim 1, further comprising switching between a 4-stroke mode and an 8-stroke mode to relieve the negative pressure condition.

4. The method of claim 1, further comprising switching between a 4-stroke mode and a 6-stroke mode to relieve the negative pressure condition.

5. The method of claim 1, further comprising switching between any one of a 2-stroke mode, a 4-stroke mode, a 6-stroke mode, and an 8-stroke mode to relieve the negative pressure condition.

6. The method of claim 1, further comprising cycling the diesel engine in a timing strategy, wherein the selective opening of the intake valve is iterated after consecutively cycling the engine with the intake valve deactivated.

7. The method of claim 6, wherein the selective opening of the intake valve is iterated as a piston of the set of reciprocating pistons approaches a bottom dead center position in the selected cylinder.

8. The method of claim 1, further comprising cycling the diesel engine in a timing strategy, wherein the selective opening of the intake valve is iterated after a set time ranging between 20 and 30 seconds with the intake valve deactivated.

9. The method of claim 1, further comprising operating a boost device to add pressure in an intake manifold of the diesel engine.

10. The method of claim 9, further comprising biasing lubrication oil on the set of reciprocating pistons using the added pressure from the boost device.

11. The method of claim 1, further comprising adjusting an oil control ring of the cycling piston to prevent excess oil leaking into a cylinder in the negative pressure condition.

12. The method of claim 1, further comprising reducing a lubricating oil pressure to piston rings of a piston of the set of reciprocating pistons in the selected cylinder.

13. The method of claim 12, wherein the piston rings of the piston of the set of reciprocating pistons further comprise a top ring, a second ring, and oil ring, and wherein the lubricating oil pressure can be adjusted to the second ring.

14. The method of claim 12, wherein the piston rings of the piston of the set of reciprocating pistons further comprise a top ring, a second ring, and oil ring, and wherein the lubricating oil pressure can be adjusted to the oil ring.

15. The method of claim 1, further comprising reducing an amount of lubricating oil sprayed in the selected cylinder.

16. The method of claim 1, further comprising adjusting a first oil pump speed for an oil pump connected to the piston of the set of reciprocating pistons of the selected cylinder, and adjusting a second oil pump speed for a second oil pump connected to the pistons of the set of reciprocating pistons in the firing remaining cylinders.

17. The method of claim 1, further comprising adjusting an oil regulator connected to the piston of the set of reciprocating pistons of the selected cylinder, and adjusting at least a second oil regulator connected to the set of reciprocating pistons in the firing remaining cylinders.

18. A method for managing an internal lubrication system for operating a multiple cylinder engine, comprising:
selectively entering cylinder deactivation mode in at least one cylinder of the multiple-cylinder diesel engine;
maintaining cylinder deactivation mode by adjusting metering of lubricating oil pressure through a piston ring pack of the at least one cylinder after cylinder deactivation mode is entered,
wherein entering cylinder deactivation mode comprises:
selectively deactivating fuel injection to the at least one cylinder;
selectively deactivating an intake valve and an exhaust valve for the at least one cylinder; and
cycling a set of reciprocating pistons in the at least one cylinder and in the at least one firing remaining cylinder.

19. The method of claim 18, wherein the piston ring pack comprises a top ring, a second ring, and an oil ring, wherein the lubricating oil pressure can be adjusted to the second ring.

20. The method of 18, further comprising reducing an amount of lubricating oil sprayed in the at least one cylinder.

21. The method of claim 18, further comprising adjusting a first oil pump speed for an oil pump connected to the piston of the set of reciprocating pistons of the selected cylinder, and adjusting a second oil pump speed for a second oil pump connected to the pistons of the set of reciprocating pistons in the firing remaining cylinders.

22. The method of claim 18, further comprising adjusting an oil regulator connected to the piston of the set of reciprocating pistons of the selected cylinder, and adjusting at least a second oil regulator connected to the set of reciprocating pistons in the firing remaining cylinders.

23. The method of claim 18, wherein maintaining cylinder deactivation mode comprises intermittently selectively opening the intake valve for the at least one cylinder to relieve a negative pressure condition.

24. The method of claim 18, wherein adjusting metering of oil comprises opening the intake valve for the at least one cylinder and boosting intake fluid to the at least one cylinder.

25. The method of claim 18, wherein adjusting metering of oil comprises opening the intake valve for the at least one cylinder when a respective piston of the set of reciprocating pistons within the at least one cylinder reaches bottom dead center in the at least one cylinder.

26. The method of claim 18, wherein adjusting metering of oil comprises opening the intake valve for the at least one cylinder when a respective piston of the set of reciprocating pistons within the at least one cylinder is near bottom dead center in the at least one cylinder.

27. A method for managing an internal lubrication system for operating a multiple-cylinder diesel engine, comprising:
selecting at least one cylinder of the multiple-cylinder diesel engine to operate in cylinder deactivation mode;
adjusting an oil feed to the selected at least one cylinder by deactivating the oil pressure to the oil feeds to the selected cylinder; and
maintaining the oil pressure in the oil feeds to firing cylinders,
wherein entering cylinder deactivation mode comprises:
selectively deactivating fuel injection to the at least one cylinder;
selectively deactivating an intake valve and an exhaust valve for the at least one cylinder;
firing remaining cylinders of the engine while the selected at least one cylinder is deactivated; and
cycling a set of reciprocating pistons in the at least one cylinder and in the firing remaining cylinders.

28. A multiple-cylinder diesel engine system, comprising:
a multiple cylinder diesel engine comprising a respective intake valve and a respective exhaust valve for each of the multiple cylinders;
a valve control system connected to selectively deactivate the respective intake valve and the respective exhaust valve for a selected cylinder of the multiple cylinder diesel engine; and
a fuel injection control system connected to selectively deactivate fuel injection to the selected cylinder while increasing fuel to firing cylinders,
wherein the multiple cylinder diesel engine enters a cylinder deactivation mode whereby:
the valve control system deactivates the respective intake valve and the respective exhaust valve for the cylinder,
the fuel injection control system deactivates fuel injection to the cylinder, and
the valve control system selectively opens one or both of the deactivated intake valve and the deactivated exhaust valve to relieve a negative pressure condition in the deactivated cylinder.

29. The engine system in claim 28 wherein the valve control system alternatively selectively opens the deactivated exhaust valve to relieve negative pressure condition in the deactivated cylinder.

30. A multiple-cylinder diesel engine system, comprising:
a multiple cylinder diesel engine comprising a respective intake valve and a respective exhaust valve for each of the multiple cylinders;
a valve control system connected to selectively deactivate the respective intake valve and the respective exhaust valve for a selected cylinder of the multiple cylinder diesel engine; and
a fuel injection control system connected to selectively deactivate fuel injection to the selected cylinder while increasing fuel to firing cylinders,
wherein the multiple cylinder diesel engine enters a cylinder deactivation mode whereby:
the valve control system deactivates the respective intake valve and the respective exhaust valve for the cylinder,
the fuel injection control system deactivates fuel injection to the cylinder, and
the valve control system selectively opens one or both of the deactivated intake valve and the deactivated exhaust valve to bias cylinder lubrication oil towards an oil pan affiliated with the deactivated cylinder.

31. The system of claim 30, further comprising selectively controlling the fuel injection control system to inject fuel in to the selected cylinder while the respective intake valve and the respective exhaust valve are deactivated.

32. The system of claim 30, further comprising selectively controlling the fuel injection control system to inject fuel in to the selected cylinder after the valve control system selectively opens one or both of the deactivated intake valve and the deactivated exhaust valve.
